(19) United States
(12) Patent Application Publication
(10) Pub. No.: US 2015/0034056 A1
(43) Pub. Date: Feb. 5, 2015

(54) Heat Exchanger For Gases, In Particular For The Exhaust Gases Of An Engine

(71) Applicant: Valeo Termico, S.A., Zaragoza (ES)

(72) Inventors: Javier Cuesta, Zaragoza (ES); Francisco Lopez Lazaro, Zaragoza (ES); Benjamin Gracia, Zaragoza (ES); Jesus Jimenez Palacios, Zaragoza (ES)

(21) Appl. No.: 14/380,096

(22) PCT Filed: Feb. 22, 2013
(86) PCT No.: PCT/EP2013/053587

§ 371 Date: Aug. 21, 2014

(30) Foreign Application Priority Data
Feb. 22, 2012 (ES) P201230270

(51) Int. Cl. F02M 25/07; F28D 1/04; F28F 19/01

(52) U.S. Cl. CPC F02M 25/0735; F28F 19/01; F28D 1/04; F02M 25/0701
USPC 123/568.12; 165/157; 165/119

(57) ABSTRACT

A heat exchanger (1) for gases, in particular for the exhaust gases of an engine, comprising a bundle of tubes (2) arranged inside a casing (3), intended for the circulation of the gases in order to exchange heat with a coolant, at least one gas tank (6) that can be fitted to one end of the casing (3) and connected to the gas recirculation line, and a particle filter (7) for filtering the exhaust gases, associated with said gas tank (6). Said filter (7) is incorporated into the gas tank (6) and forms a single inseparable part that can be fitted to the casing (3) of the exchanger (1). Preferably, the filter (7) is incorporated into the gas tank (6) by welding. A filter which is fully incorporated into the gas tank in a single part is obtained, which therefore facilitates the assembly thereof to the exchanger casing.

The present invention relates to a heat exchanger for gases, in particular for the exhaust gases of an engine.

The invention is used more specifically in heat exchangers for recirculating exhaust gases of an engine (EGRC).

### BACKGROUND OF THE INVENTION

The main function of EGR exchangers is to exchange heat between the exhaust gases and the coolant, with the aim of cooling the gases.

Currently, EGR heat exchangers are predominantly used in diesel applications, in order to reduce emissions, and are also used in petrol applications in order to reduce fuel consumption.

The tendency on the market is to reduce the size of engines and to apply EGR heat exchangers not only in high-pressure (HP) applications but also in low-pressure (LP) applications, both of which have an impact on the design of EGR heat exchangers. At the same time as vehicle manufacturers are demanding higher performance EGR heat exchangers, the space available for accommodating the heat exchanger and its components is becoming ever smaller, making it increasingly difficult to incorporate said heat exchangers.

Moreover, in many applications, the flow of the coolant for cooling the exhaust gases seems to be decreasing, although the performance of the exchanger has increased.

The current configuration of EGR exchangers on the market corresponds to a metal heat exchanger which is generally made of stainless steel or aluminium.

There are basically two types of EGR heat exchanger: a first type consists of a casing inside which a bundle of parallel tubes is arranged, through which tubes the gases pass, the coolant circulating in the casing outside the tubes; and the second type is composed of a series of parallel plates forming the heat exchange surfaces, such that the exhaust gases and the coolant flow between two plates, in alternating layers, with the option of including ribs to improve the heat exchange.

In the case of heat exchangers having a bundle of tubes, the tubes and the casing may be joined in various ways. Generally, the tubes are fixed at their ends between two support plates which are connected at each end of the casing, the two support plates having a plurality of holes for installing the respective tubes.

Said support plates are, in turn, attached to means for connecting to the recirculation line, which means may consist of a V-shaped fitting or a peripheral connection collar or flange, depending on the design of the recirculation line in which the exchanger is fitted. The peripheral collar may be joined to a gas tank, so that the gas tank forms an intermediate part between the casing and the collar, or the collar may be joined directly to the casing.

In the two types of EGR exchanger, the majority of the components thereof are metal, and they are therefore joined using mechanical means and then welded in a furnace, or arc- or laser-welded, in order to ensure the appropriate sealing required by this application.

Some EGR exchangers also comprise a filter in the exhaust line, which filter is usually formed by an independent component, although it may be in part incorporated in the EGR exchanger.

EP2273095 relates to a heat exchanger comprising a fluid filter incorporated in said exchanger, which filter comprises a filter region extending over a planar surface. This filter is designed as a coupling and is arranged between the connection flange and the gas tank by means of screwing elements.

EP2194351 relates to a heat exchanger comprising a particle filter for filtering exhaust gases, said filter being structurally incorporated inside the gas inlet tube of the heat exchanger.

FR2938051 relates to a heat exchanger comprising a filter located in a position selected so that the filter is arranged close to a far edge of the tube bundle.

However, these filters have the drawback of requiring a laborious and slow assembly process, since they entail the use of additional couplings and fixing by means of screwing elements. Furthermore, the volume of said filters increases the size of the exchanger, causing problems to arise when fitting said exchanger in the engine compartment.

### DESCRIPTION OF THE INVENTION

The aim of the heat exchanger for gases, in particular for the exhaust gases of an engine, according to the present invention, is to overcome the drawbacks of the exchangers known in the prior art, by providing a particle filter which is more cost-effective and easier to fit in the exchanger.

The heat exchanger for gases, in particular for the exhaust gases of an engine, to which the present invention relates, is of the type comprising a bundle of tubes arranged inside a casing, intended for the circulation of the gases involving heat exchange with a coolant, at least one gas tank which can be fitted to one end of the casing and connected to the gas recirculation line, and a particle filter for filtering the exhaust gases, which is associated with said gas tank, and said heat exchanger is characterised in that said filter is incorporated in the gas tank and forms a single inseparable part which can be fitted to the casing of the exchanger.

This gives rise to a filter which is fully incorporated in the gas tank in a single part, which thus makes it easier to join said filter to the casing of the exchanger.

Advantageously the filter is incorporated in the gas tank by welding. This provides simpler fixing of the filter to the gas tank, as it is not necessary for the filter to have a metal collar or intermediate fastenings, nor does it need screwing elements, in order to be joined to the gas tank, as was the case for the known filters.

The gas tank may also be joined directly to the core of the heat exchanger, by furnace brazing, and it is not necessary to use a separate part joined by means of screwing elements, as was the case in the prior art.

The filter is preferably joined to the gas tank by spot welding or arc welding.

Optionally, the filter is also be joined to the gas tank by furnace brazing. Joining by spot welding or arc welding is generally sufficient to ensure that the filter is correctly fixed. Nonetheless, it is possible to improve the fixing by means of additional furnace brazing.

According to an embodiment of the invention, the filter comprises a concave screen, in the form of a tray, having a flat peripheral wing intended for integral joining to the gas tank.

The design in the form of a concave screen makes it possible to increase the surface area of filtration, and secondly, the planar surface of the peripheral wing makes it easier to fix the filter to the gas tank by welding, without the need for intermediate parts or screwing elements.

Advantageously, the gas tank comprises a flat peripheral rim in its inner portion, intended for receiving the peripheral wing of the filter for the purpose of joining said rim to said wing. This ensures permanent and robust weld fixing between the two parts.

The advantages provided by the present invention are summarised below:
A more cost-effective filter is obtained which is also easier to produce since it is formed only of the filtration screen which comprises the peripheral wing made of the same material. Nonetheless, if desired, it is also possible to include a metal plane around the screen.
The incorporation of the filter simplifies the design of the exchanger by eliminating the need to include a collar, a coupling and screwing means. The outcome is a significant reduction in the cost of assembly.
Incorporating the filter in the gas tank means that the heat exchanger has a smaller volume compared with other solutions which require a collar or an additional part.
The process of assembling the exchanger is simplified by reducing the number of parts, and also because the welding process is much more rapid than the process involving screwing elements.

### BRIEF DESCRIPTION OF THE DRAWINGS

In order to facilitate the description of what is set out above, drawings are appended in which there is illustrated schematically and only by way of non-limiting example a practical case of an embodiment of the heat exchanger for gases, in particular for the exhaust gases of an engine, according to the invention, in which:

FIG. 1 is a schematic longitudinal section of part of a heat exchanger, showing the filter fitted to the gas tank, according to the invention;

FIG. 2 is a perspective view of the filter according to the invention;

FIG. 3 is a perspective view of the gas tank, showing the peripheral fitting rim intended to receive the filter;

FIGS. 4 and 5 show two exploded perspective views of the filter and the gas tank in cross section; and

FIG. 6 is a perspective view according to FIG. 4, showing the filter incorporated in the gas tank.

### DESCRIPTION OF A PREFERRED EMBODIMENT

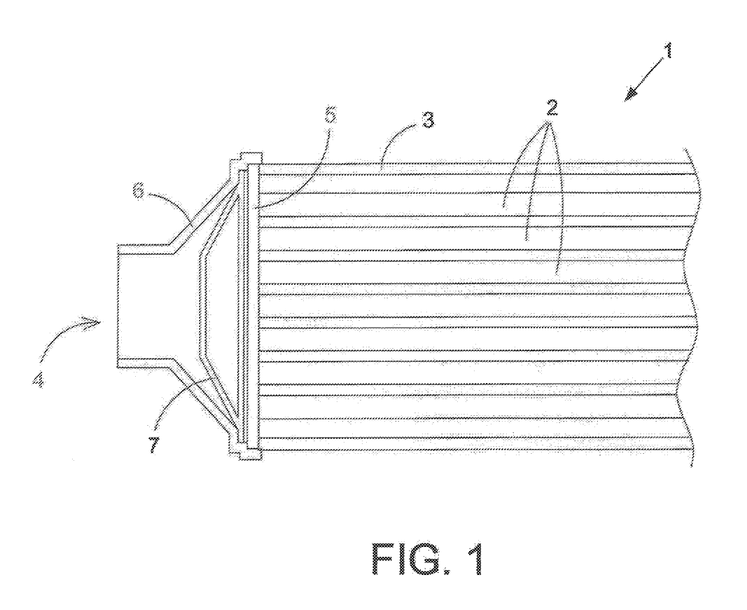

FIG. 1 shows part of a heat exchanger 1, comprising a bundle of tubes 2 arranged inside a casing 3, delimiting a gas inlet 4 and outlet, said tubes 2 being intended for the circulation of the gases involving heat exchange with a coolant. The tubes 2 are fixed via their ends between two support plates 5 fitted to each end of the casing 3, the two support plates 5 having a plurality of holes for installing the respective tubes 2.

In this case, the exchanger 1 comprises a gas tank 6 fitted to the casing 3 at the gas inlet 4 end, and connected to the gas recirculation line.

The exchanger 1 also comprises a particle filter 7 for filtering the exhaust gases, incorporated in the gas tank 6 and forming a single inseparable part which can be fitted to the casing 3 of the exchanger. In this way, by obtaining a single part, it is made easier to join said part to the casing 3 of the exchanger 1.

The filter 7 is incorporated in the gas tank 6 by welding, either by spot welding or by arc welding. This makes it easier to fix the filter 7 to the gas tank 6, as it is not necessary for the filter 7 to have a metal collar or intermediate fastenings, nor does it require screwing elements in order to be joined to the gas tank 6.

Joining by spot welding or arc welding is generally sufficient to ensure that the filter 7 is correctly fixed. Nonetheless, in order to improve the fixing of the filter 7 to the gas tank 6, furnace brazing can also be applied.

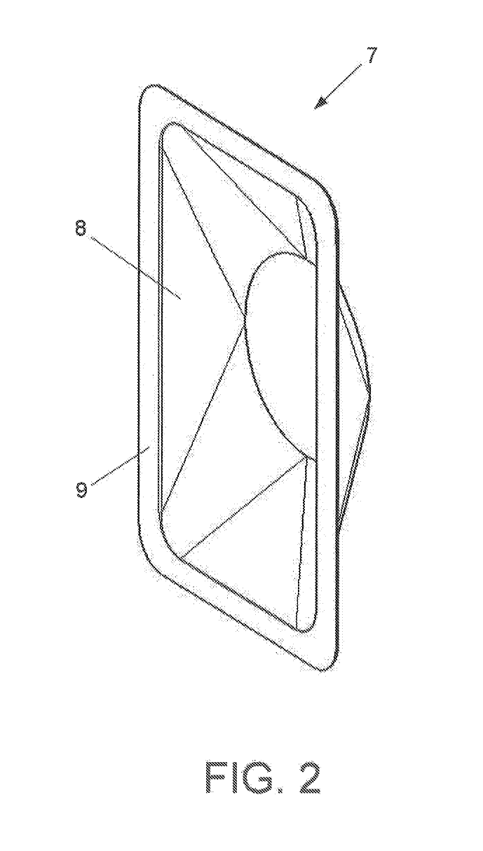

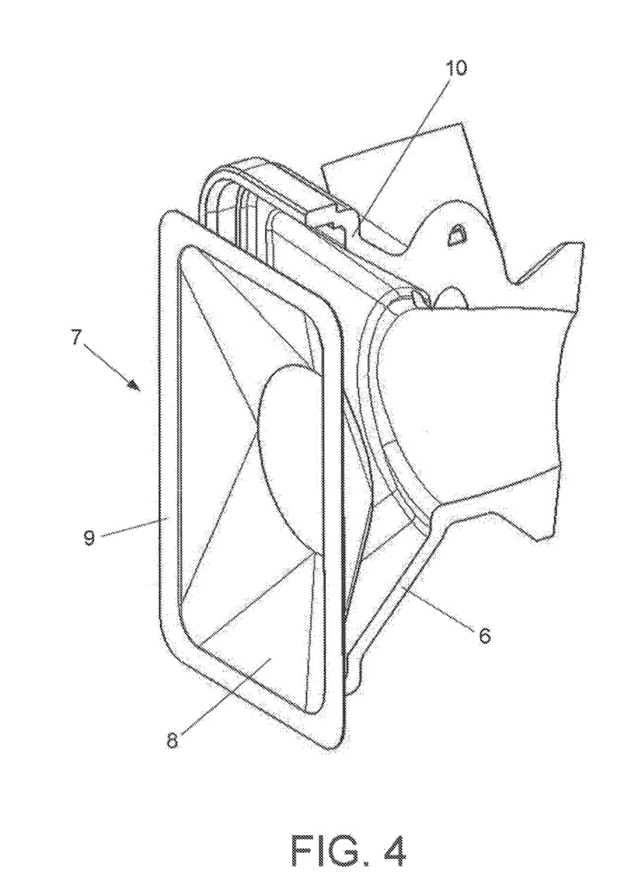

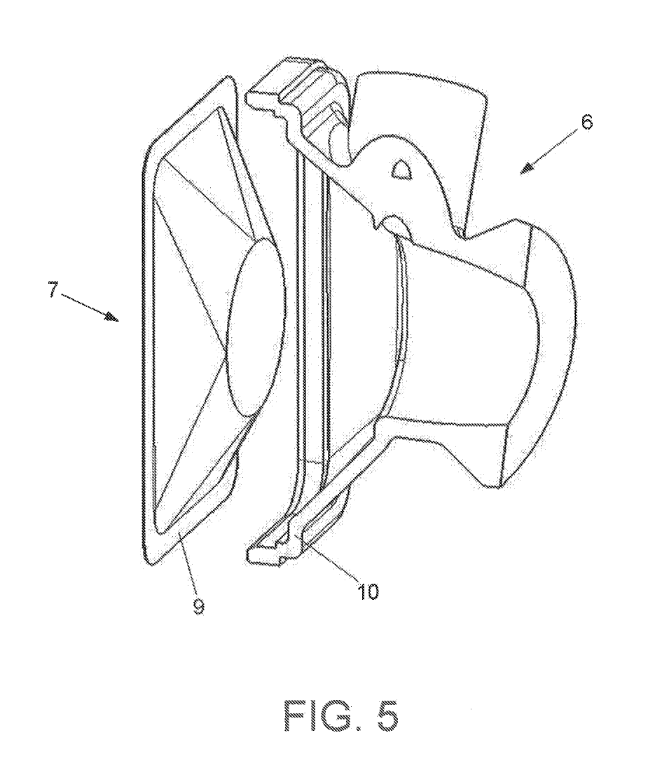

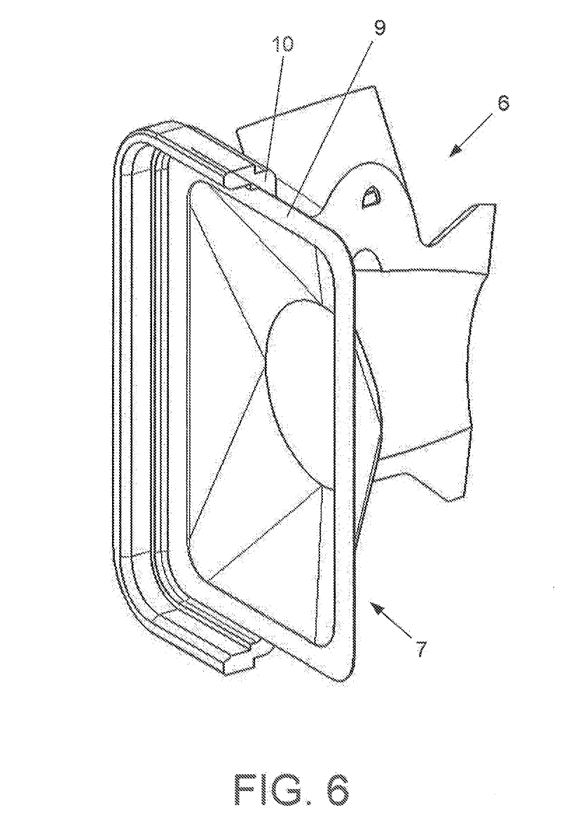

As can be seen in FIGS. 2 to 6, the filter 7 comprises a concave screen 8, in the form of a tray, having a flat peripheral wing 9 intended for integrally joining the filter to the gas tank 6. The design in the form of a concave screen 8 makes it possible to increase the surface area of filtration, and secondly, the planar surface of the peripheral wing 9 makes it easier to fix the filter 7 to the gas tank 6 by welding, without the need for intermediate parts or screwing elements.

The gas tank 6 comprises a flat peripheral rim 10 in its inner portion, intended for receiving the peripheral wing 9 of the filter 7 for the purpose of joining said rim to said wing. This ensures permanent and robust weld fixing between the two parts.

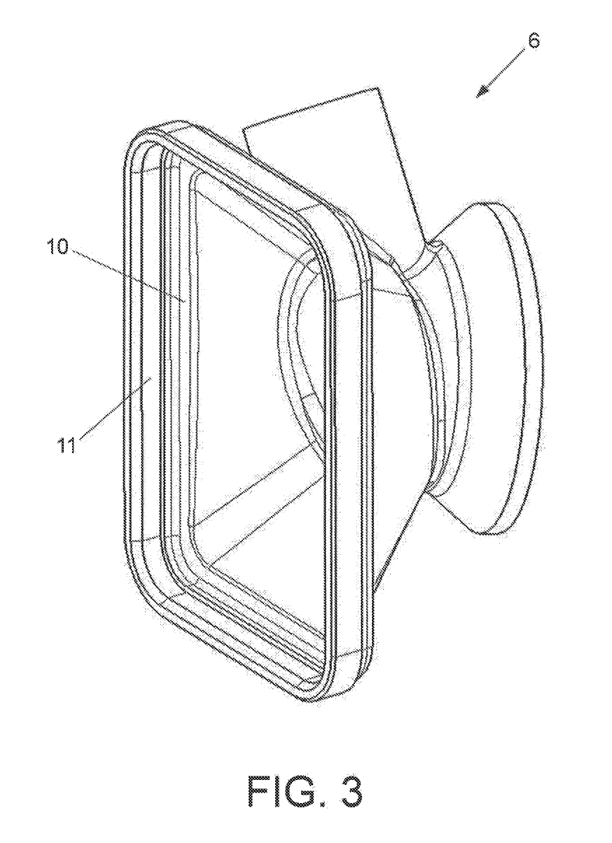

The gas tank 6 also comprises another collar 11 intended to nest and fit together with the rim of the casing 3, as can be seen in FIG. 3.

1. A heat exchanger (1) for exhaust gases of an engine, with the heat exchanger (1) comprising:
a bundle of tubes (2) arranged inside a casing (3), for circulation of the exhaust gases for heat exchange with a coolant,
at least one gas tank (6) which can be fitted to one end of the casing (3) and connected to a gas recirculation line, and
a particle filter (7) for filtering the exhaust gases, which is associated with the gas tank (6),
wherein the particle filter (7) is incorporated in the gas tank (6) and forms a single inseparable part which can be fitted to the casing (3) of the exchanger (1).

2. A heat exchanger (1) according to claim 1, wherein the filter (7) is incorporated in the gas tank (6) by welding.

3. A heat exchanger (1) according to claim 2, wherein the filter (7) is joined to the gas tank (6) by spot welding or arc welding.

4. A heat exchanger (1) according to claim 3, wherein the filter (7) is further joined to the gas tank (6) by furnace brazing.

5. A heat exchanger (1) according to claim 2, wherein the filter (7) comprises a concave screen (8) in the form of a tray, having a flat peripheral wing (9) intended for integrally joining the filter (7) to the gas tank (6).

6. A heat exchanger (1) according to claim 5, wherein the gas tank (6) comprises an inner portion and a flat peripheral rim (10) within the inner portion for receiving the peripheral wing (9) of the filter (7) to join the rim to the wing.

7. A heat exchanger (1) according to claim 3, wherein the filter (7) comprises a concave screen (8) in the form of a tray, having a flat peripheral wing (9) intended for integrally joining the filter to the gas tank (6).

8. A heat exchanger (1) according to claim 4, wherein the filter (7) comprises a concave screen (8) in the form of a tray, having a flat peripheral wing (9) intended for integrally joining the filter to the gas tank (6).
